(19) United States
(12) Patent Application Publication
(10) Pub. No.: US 2003/0125118 A1
(43) Pub. Date: Jul. 3, 2003

(54) Laser-welded driveshaft and method of making same

(76) Inventors: Suresh Raghavan, Grosse Pointe Farms, MI (US); Mark L. Berns, Northwood, OH (US); Robert Dines, Waterford, MI (US); David M. Douglass, Plymouth, MI (US)

Correspondence Address: BRINKS HOFER GILSON & LIONE, P.O. Box 10395, Chicago, IL, 60610, US

(21) Appl. No.: 10/035,066

(22) Filed: Dec. 27, 2001

(51) Int. Cl. B23K 26/28; B23K 26/00

(52) U.S. Cl. 464/182; 219/121.64

(57) ABSTRACT

The present invention involves a laser-welded driveshaft and method of making same. The laser-welded driveshaft comprises a tube and a yoke laser welded to the tube. The tube has a driveshaft wall extending to an open end, wherein the wall has inner and outer surfaces. The yoke includes a tube-engaging pilot which is disposed through the open end and the yoke is laser-welded to the open end of the tube.

### BACKGROUND OF THE INVENTION

The present invention relates to a laser-welded driveshaft and a method of making the driveshaft.

Several welding processes are known and have been widely used in various industries, such as the automotive industry. Various automotive parts are made by welding processes, for example, gas metal arc (GMA) welding process. For instance, an automotive driveshaft may be GMA welded to provide a driveshaft assembly for the vehicle. Such automotive driveshafts include driveshafts which transmit power from the transmission to the differential for rear-wheel drive vehicles.

Current methods of making automotive driveshafts are adequate, but may be improved. In the process of GMA welding, a significant amount of heat is used to weld a yoke to a tube of a driveshaft. In many situations, the amount of heat used is absorbed by the welding parts and typically causes at least some distortion between the tube and the yoke. Distortion may be a result of unacceptable driveshaft runout or imbalance requiring a straightening process and a weight balancing process to the driveshaft. An excess of runout or imbalance results in unacceptable noise, vibration, and harshness to a vehicle in which the driveshaft is used. Given the ever so increasing demands for reduced distortion and lessened weld time per cycle, manufacturers continue to research new ways in improving efficiency in welding of driveshafts.

### BRIEF SUMMARY OF THE INVENTION

Thus, an object of the present invention is to provide an improved method of welding a joint of a driveshaft resulting in less heat input and less time consumed per cycle.

Another object of the present invention is to provide an improved method of welding a driveshaft wherein noise, vibration, and harshness (NVH), distortion, runout, and imbalance are reduced using a given power and speed.

The present invention generally provides a laser-welded driveshaft and a method of laser-welding the driveshaft of a vehicle. The laser-welded driveshaft of the present invention is made by a laser-welding method which lessens NVH, distortion, runout, and imbalance, with a given laser power and laser travel speed. The present invention provides a more efficient method of welding a driveshaft which is more rigid than current driveshafts made by other methods at given laser power and laser travel speed. The method involves using a neodymium:yttrium aluminum garnate (Nd:YAG) laser.

Further objects, features and advantages of the invention will become apparent from consideration of the following description and the appended claims when taken in connection with the accompanying drawings.

### BRIEF DESCRIPTION OF THE DRAWINGS

FIG. 1 is a side view of a laser-welded driveshaft in accordance with one embodiment of the present invention;

FIG. 2 is a cross sectional view of the laser-welded driveshaft in FIG. 1 taken along lines 2-2;

FIG. 3 is an exploded view of the driveshaft in FIG. 1;

FIG. 4 is an enlarged view of circle 4 in FIG. 1;

FIG. 5 is a side view of a driveshaft being laser-welded in accordance with one method of the present invention; and

FIG. 6 is a flow chart depicting one method of laser welding a driveshaft in accordance with one embodiment of the present invention.

### DETAILED DESCRIPTION OF THE INVENTION

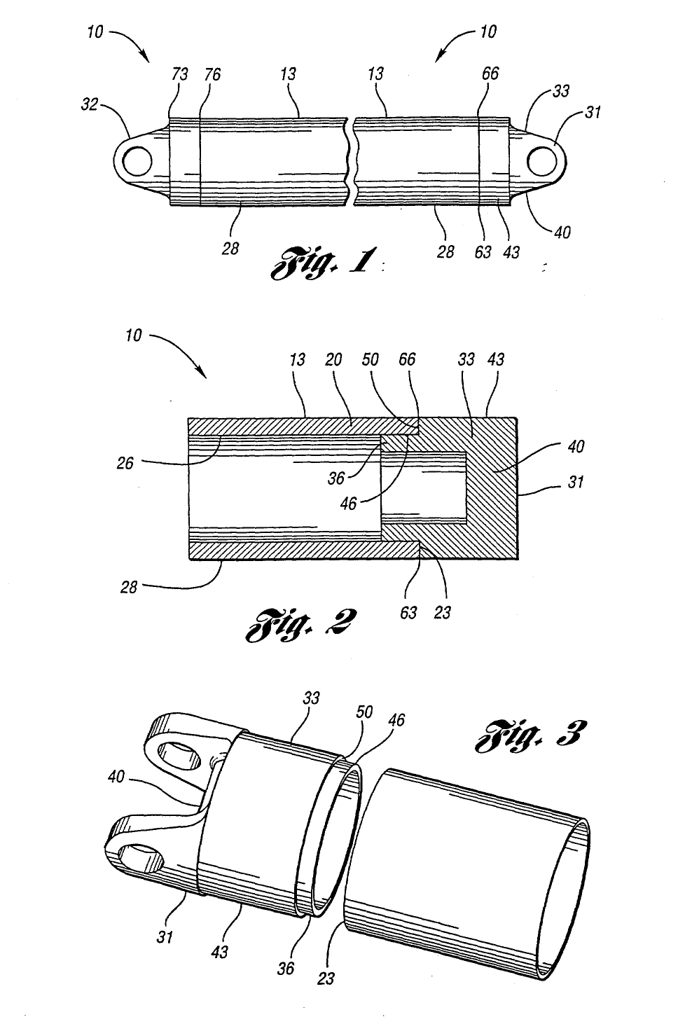

FIG. 1 illustrates laser-welded driveshaft 10 comprising tube 13 having central axis A and first and second laser-welded yokes 31, 32 attached to the tube 13 by laser-welding. As shown in FIGS. 1-2, tube 13 includes driveshaft wall 20 extending to first and second open ends 23, 25. Driveshaft wall 20 further has inner and outer surfaces 26, 28. As shown in FIGS. 1-4, first yoke 31 is laser-welded to first open end 23 of tube 13. Yoke 31 has body portion 33 and tube-engaging pilot 36 extending from body portion 33. Body portion 33 has head 40 and outer wall 43 extending therefrom to tube-engaging pilot 36. Pilot 36 has contact wall 46 which extends from outer wall 43 of body portion 33. This defines an outer shoulder 50 which engages open end 23 of tube 13. As shown, contact wall 46 is radially formed to insert through open end 23 and engage inner surface 26 of driveshaft wall 20. This defines a first tube-yoke interface 63 at which yoke 31 is laser-welded to open end 23 forming a first welding joint 66 of the driveshaft.

Second yoke 32 is laser-welded to second open end 25 of tube 13. Yoke 32 has body portion 34 and tube-engaging pilot 37 extending from body portion 34. Body portion 34 has head 41 and outer wall 44 extended therefrom to tube-engaging pilot 37. Pilot 37 is configured essentially the same as pilot 36 of yoke 31. For example, pilot 37 has contact wall 47 which extends from outer wall 44 of body portion 34 similar to pilot 36. This defines an outer shoulder 51 which engages open end 25 similarly as outer shoulder 50 engages open end 23 of tube 13. Similar to wall 46, contact wall 47 is radially formed to insert through open end 25 and engage inner surface 26 of driveshaft wall 20. This defines a second tube-yoke interface 73 at which yoke 32 is laser-welded to open end 25 forming a second welding joint 76 of the driveshaft.

Preferably, but not necessarily, the driveshaft is a tubular member being about 65 inches in length and having about a 4 inch diameter. Preferably, the tube and the yoke are made of aluminum or aluminum alloy, e.g., 6061 aluminum alloy T6 condition. Aluminum provides more challenges in welding than other metals or materials, since aluminum is more conductive and absorbs more heat than many other metals used in welding, e.g., steel. Moreover, the yoke preferably has the same outer diameter as the tube.

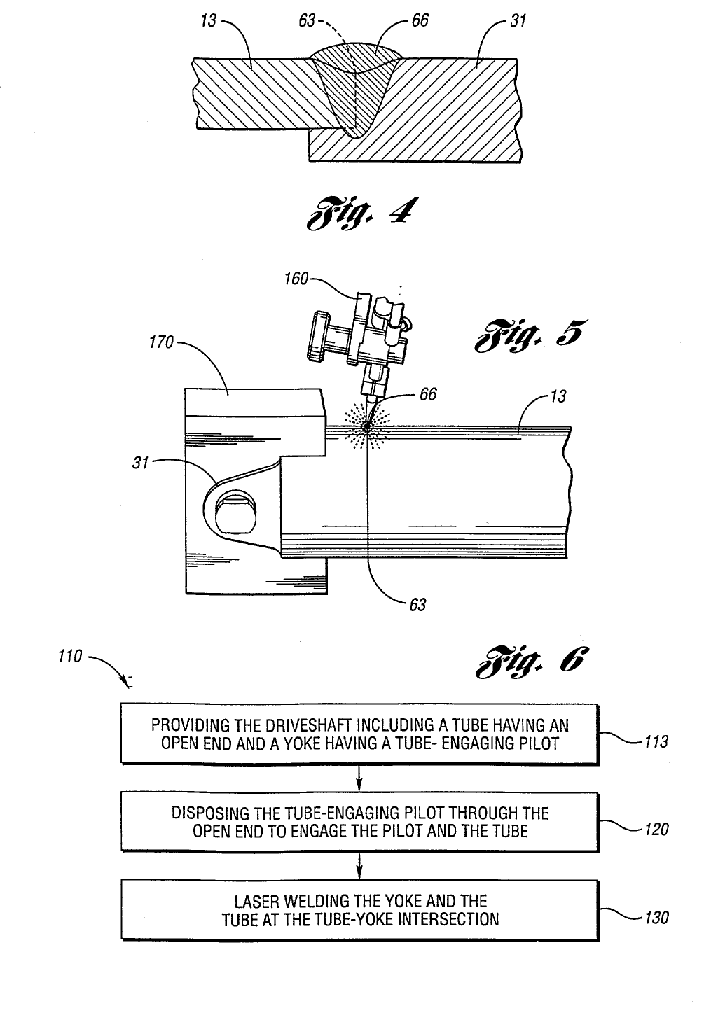

As shown in FIGS. 4-5, in this embodiment, yokes 31, 32 are laser-welded to the open ends 23, 25, respectively. Preferably, but not necessarily, this is done with a metal or metal alloy wire feed. Preferably but not necessarily, the wire feed is comprised of the same material as the driveshaft, for example, aluminum or aluminum alloy. However, any suitable metal or metal alloy may be used without falling beyond the scope or spirit of the present invention. Preferably, but not necessarily, the laser-welded driveshaft 10 is balanced at about 0.2 inches-ounces or less, has a diameter preferably greater than about 3 inches and has a wall thickness of preferably between about 0.03-0.20 inch. Of course, other ranges may be used without falling beyond the scope or spirit of the present invention.

FIG. 6 depicts one method 110 of laser-welding a welding joint for a vehicle driveshaft in accordance with one embodiment of the present invention. The method 110 includes providing a typical rotating machine used in welding members together in box 113. The machine or equipment used is configured to receive and retain the tube and the yoke (mentioned above) such that the tube-engaging pilot of the yoke is disposed through the open end of the tube to press fit into the tube. The machine used is also preferably configured to rotate the tube about its central axis for welding the yoke and the tube. Such machine may include a rotating position machine as known in the art. However, other suitable machines may be used to rotate the tube without falling beyond the scope or spirit of the present invention.

The method 110 further includes providing the driveshaft assembly (as mentioned above) which includes the tube having the open ends, and includes the yokes each having the tube-engaging pilot in box 116. The tube and yoke are then chucked within the rotating machine so that the tube and yoke may be secured therein while rotating about its central axis at a travel speed of between about 5-20 revolutions per minute (rpm).

The method further includes providing a laser-welding source or machine in box 118 for laser welding the yoke and the tube, wherein the laser-welding source emits a laser having a power of at least about 2.5 kilowatts for the travel speed ranging between about 5-20 rpm. In this embodiment, the laser-welding source provides a four kilowatt (kW) neodymium:yttrium aluminum garnate (Nd:YAG) laser with dual spot optics having a focal length of 160 millimeters and an aluminum alloy wire feed. Of course, other ranges of power and laser types may be used, for example an eight kW CO₂ laser with single spot optics.

However, for this embodiment of the present invention, welding behaviors are significantly dissimilar between Nd:YAG lasers and CO₂ lasers, resulting in dissimilar welding results favorable to the Nd:YAG lasers. It has been determined that a four kilowatt (kW) Nd:YAG laser provides a higher power density, a reduced chance of weld defects, a greater flexibility in transporting the laser beam, and a laser beam which is more readily absorbed by metals than other lasers used in the industry, e.g., CO₂ lasers. For example, the wavelength of a Nd:YAG laser (1.06 microns) is shorter than the wavelength of a CO₂ laser (10.6 micron). Shorter wavelengths result in higher absorptivities and smaller focus spot sizes, providing higher power densities. Thus, for the same power, beam quality and optics, the power density is higher for Nd:YAG lasers than CO₂ lasers. Thus, for a given weld, this results in a faster laser travel speed than a CO₂ laser. Additionally, for the same laser speed and power used in a CO₂ laser, this provides a deeper penetration for the weld.

Moreover, shorter wavelengths of lasers interact less with laser-induced plasmas, i.e., ionized metal and shield gases. An example may include gaseous argon plasmas used as a shield gas. This provides a more stable plasma and a more stable keyhole or vapor column, resulting in relatively consistent power to the weld pool to reduce the chances of having weld defects. It is also preferred to use a Nd:YAG laser, since Nd:YAG lasers may use an argon shield gas whereas CO₂ lasers require a helium shield gas. Argon gas is less expensive than other gases used in welding and is more readily used in the welding industry. Additionally, shorter wavelength lasers are more readily absorbed by metals than longer wavelength lasers.

Also, Nd:YAG laser beams are preferred, since Nd:YAG laser beams can be delivered via fiber optics. CO₂ laser beams require transmission through the atmosphere using hard mirrors as known in the art. Thus, Nd:YAG lasers have greater flexibility in transporting the beam.

It has also been determined that, for this embodiment of the present invention, a laser source with dual spot optics is preferred over a laser source with single spot optics. A laser source with dual spot optics provides a weld having a wider weld pool than a laser source with a single spot optic. Laser beams from high power industrial lasers are generally collimated laser beams ranging in diameter. In this embodiment, to obtain power densities for welding the joint of the driveshaft, the laser beams are focused to predetermined spot size diameters, e.g., about 0.5 millimeters or less. In a single spot optic laser, the optics focus a single output beam onto the joint of the driveshaft, creating a single welding spot on the driveshaft. In this embodiment, when dual spot optics are used, the optics thereof produce two focused laser beams on the welding joint of the driveshaft. The dual spot optics generate two laser beams to predetermined spot sizes. Preferably, but not necessarily, the two laser beams are in-line with the direction of laser welding. That is, the laser beams are focused one in front of the other during laser welding of the driveshaft.

A dual spot weld pool is a larger or wider weld pool which provides more time for the weld joint to close relative to a single spot weld pool. A dual spot keyhole is larger than a single spot keyhole. Generally, a larger keyhole aids in preventing the keyhole from collapsing. This allows more time for trapped gases to escape from the weld pool. This effectively hampers porosity formation, resulting in a less porous weld joint relative to a single spot weld joint. In turn, a dual spot weld joint has more rigidity and strength than a single spot weld joint.

The method of the present invention further includes checking the set laser power and speed to verify the parameters at which the laser-welding source is to laser-weld. The laser power may be checked with a typical power meter as known. The speed may be checked by simply having a technician manually confirm the set laser power on the laser-welding machine and the speed on the rotating machine. After the power and the speed are verified, the laser-welding source laser-welds the yoke and the tube forming the welding joint of the driveshaft. The yoke and tube may be made of a heat-treatable aluminum alloy. If so, laser-welding may be performed with a metal or metal alloy feed wire, such as aluminum alloy. During laser-welding, a shielding gas is introduced to shield the tube-yoke interface, preventing air from contacting the welded material. This may be accomplished by any suitable means known in the art. Preferably, but not necessarily, the shielding gas may comprise of gaseous argon. During welding, in this embodiment, the tube and yoke is rotated at least about 360° as the laser welds the tube and the yoke.

After laser-welding, the driveshaft is measured for run-out. As known in the art, runout is a measurement which indicates the tube profile of the driveshaft based on its concentricity. A measure of runout may be performed with a typical dial indicator. The dial indicator may have a dial gauge to measure the diameter variance at selective points along the driveshaft, e.g., adjacent the first and second ends and a portion adjacent the middle of the driveshaft. The dial indicator determines the runout of the driveshaft as typically performed in the art.

In this embodiment, if runout of the driveshaft is determined to be greater than about 0.02 inches, then a straighten process is performed on the driveshaft. This may be accomplished with a typical straightening device. The straightening device retains the welded tube along an axis X by any suitable means as known in the art. The straightening device then rotates the driveshaft about axis X at a predetermined rpm, e.g., 3000 rpm. The straightening device further includes upper and lower concave presses, wherein the upper press is raised to contact and press the driveshaft as it rotates about axis X. The contact between the presses and the driveshaft “straightens” the driveshaft and lowers runout of the driveshaft and, thus, enhances the tube profile of the driveshaft based on its concentricity.

After the straightening process, the driveshaft is measured for mass balance which indicates weight distribution or imbalance along the driveshaft. This may be accomplished with a typical balance machine. The driveshaft is received and chucked on the balance machine, and rotated at a predetermined rpm, e.g., 3200 rpm. A sensor on the balance machine measures the weight distribution or imbalance of the driveshaft. In this embodiment, if imbalance is determined to be greater than 0.2 inch-ounce, then the balance machine identifies a location on the driveshaft the imbalance is located and a weighted member is added to the yoke. This balances the driveshaft at a level preferably 0.2 inch-ounce or lower.

It is to be understood that, although a Nd:YAG laser is preferred in this embodiment, any other suitable laser may be used, e.g., a CO₂ laser.

While the present invention has been described in terms of preferred embodiments, it will be understood, of course, that the invention is not limited thereto since modifications may be made to those skilled in the art, particularly in light of the foregoing teachings.

1. A method of laser-welding a tube-yoke interface for a vehicle driveshaft, the method comprising:
providing the driveshaft including a tube having an open end and a yoke having a tube-engaging pilot;
disposing the tube-engaging pilot through the open end to engage the pilot and the tube, defining the tube-yoke interface; and
laser-welding the yoke and the tube at the tube-yoke interface forming a welding joint to define the driveshaft.

2. The method of claim 1 further comprising:
providing a laser-welding source for laser-welding the yoke and the tube, wherein the laser-welding source includes a power of at least about 2.5 kilowatts; and
rotating the tube and yoke at a travel speed ranging between about 5-20 revolutions per minute.

3. The method of claim 1 further comprising shielding the tube-yoke interface as the yoke and the tube are laser-welded.

4. The method of claim 3 wherein shielding includes shielding the tube-yoke interface with gaseous argon.

5. The method of claim 2 further comprising rotating the tube at least 360° when the yoke and the tube are laser-welded.

6. The method of claim 1 further comprising:
measuring runout of the driveshaft, after laser-welding the tube-yoke interface;
straightening the driveshaft, if runout is measured to be greater than 0.02 inches;
measuring imbalance of the driveshaft; and
adding weight to the driveshaft, if imbalance is measured to be greater than 0.2 inch-ounce.

7. The method of claim 2 wherein the laser-welding source emits a Nd:YAG laser having dual spot optics.

8. The method of claim 2 further comprising verifying the power and the speed at which the laser-welding source laser-welds the yoke and the tube.

9. A laser-welded driveshaft comprising:
a tube having a driveshaft wall extending to an open end, the wall having inner and outer surfaces; and
a yoke laser-welded to the open end of the tube.

10. The laser-welded driveshaft of claim 9 wherein the yoke has a body portion and a tube-engaging pilot extending from the body portion, the body portion having a head and an outer wall extending therefrom to the tube-engaging pilot, the pilot having a contact wall extending from the outer wall defining an outer shoulder to engage the open end of the tube, the contact wall being radially formed to insert through the open end and engage the inner surface of the driveshaft wall.

11. The laser-welded driveshaft of claim 9 wherein the yoke is laser-welded to the open end of the tube with a metal alloy.

12. The laser-welded driveshaft of claim 11 wherein the driveshaft comprises the metal alloy.

13. The laser-welded driveshaft of claim 12 wherein the metal alloy is aluminum alloy.

14. The laser-welded driveshaft of claim 9 wherein the driveshaft is configured to have a balance less than 0.2 in-oz balance.

15. The laser-welded driveshaft of claim 9 wherein the tube has a diameter greater than about 3 inches.

16. A laser-welded driveshaft comprising:
a tube having a driveshaft wall extending to an open end, the wall having inner and outer surfaces; and
a yoke Nd:YAG laser-welded to the open end of the tube, the yoke having a body portion and a tube-engaging pilot extending from the body portion, the body portion having a head and an outer wall extending therefrom to the tube-engaging pilot, the pilot having a contact wall extending from the outer wall defining an outer shoulder to engage the open end of the tube, the contact wall being radially formed to insert through the open end and engage the inner surface of the driveshaft wall.

17. The laser-welded driveshaft of claim 16 wherein the driveshaft comprises the metal alloy.

18. The laser-welded driveshaft of claim 17 wherein the metal alloy is aluminum alloy.

19. The laser-welded driveshaft of claim 16 wherein the driveshaft is configured to have a balance less than 0.2 in-oz balance.

20. A method of laser-welding a tube-yoke interface for an aluminum vehicle driveshaft, the method comprising:
providing the aluminum driveshaft including a tube having an open end and a yoke having a tube-engaging pilot;
disposing the tube-engaging pilot through the open end to engage the pilot and the tube, defining the tube-yoke interface; and
YAG laser-welding the yoke and the tube with a feed wire at the tube-yoke interface forming a welding joint to define the driveshaft.
